(19) United States
(12) Patent Application Publication
(10) Pub. No.: US 2005/0250514 A1
(43) Pub. Date: Nov. 10, 2005

(54) Mode Control Method of Mobile Wireless Communication Device

(76) Inventors: Liang-Fang CHEN, Tai-Nan City (TW); Chih-Lung TSAN, Tao-Yuan Hsien (TW)

Correspondence Address: NORTH AMERICA INTELLECTUAL PROPERTY CORPORATION, P.O. BOX 506, MERRIFIELD, VA, 22116, US

(21) Appl. No.: 10/908,306

(22) Filed: May 6, 2005

(30) Foreign Application Priority Data
May 10, 2004 (TW) 093113097

(51) Int. Cl. H04Q 7/20

(52) U.S. Cl. 455/456.1; 455/426.1; 455/552.1

(57) ABSTRACT

The present invention discloses a mode control method used in a mobile wireless communication device. The mobile wireless communication device has a first communication mode and a second communication mode. The method includes the following steps: calculating a motion speed of the mobile wireless communication device; and controlling the mobile wireless communication device to switch between the communication modes according to the motion speed.

### BACKGROUND OF INVENTION

1. Field of the Invention

The present invention relates to mobile communication, and more particularly, to a mode control method that switches a mobile wireless communication device between different communication modes according to a motion speed of the mobile wireless communication device.

2. Description of the Prior Art

Mobile communication has become a boom industry during recent years. Many kinds of wireless communication technologies have been developed. Taking mobile phone systems as an example, there are two kinds of widely applied mobile phone systems, which are the PHS system (which stands for Personal Handy-phone System) and the GSM/GPRE/EDGE system (which stands for Global System for Mobile Communications/General Packet Radio Service/ Enhanced Data Rates for Global Evolution).

In contrast to the GSM/GPRS/EDGE system, the PHS system uses a lower transmission power. Since lower transmission power corresponds to less power consumption, for a mobile communication user, an advantage of the PHS system is that a PHS handset generally has a longer stand-by time than that of a GSM/GPRS/EDGE handset. Another benefit for the PHS handset user is that a lower communication rate is charged. Although the GSM/GPRS/EDGE system has more stable communication quality, a higher communication rate is usually charged. On account of the above-mentioned characteristics, some mobile communication users have begun to carry two handsets belonging to two different systems at the same time. A PHS handset with lower communication rate is used for dialing out; and a GSM/GPRS/EDGE handset is used for receiving calls. For mobile communication users who use their phones very regularly, this strategy can save them a lot of money.

There are some dual-mode handsets available on the market having both a GSM/GPRS/EDGE mode and a PHS mode. With these types of handsets, a mobile communication user who wishes to use both the GSM/GPRS/EDGE system and the PHS system does not have to carry two handsets at the same time. However, this kind of dual-mode handset must synchronize with both GSM base stations and PHS base stations, which increases additional power consumption and consequently decreases the stand-by time of the dual-mode handset.

In reality, for a motionless user or a user with low motion speed, deactivating the GSM/GPRS/EDGE mode and using only the PHS mode would be sufficient for both voice and data communication. With only the PHS mode being used, less power is consumed and the stand-by time of the dual mode handset is increased. Under a higher motion speed, the communication quality of the PHS mode deteriorates and, in this case, the GSM/GPRS/EDGE mode becomes far more stable than the PHS mode. Therefore, a dual mode mobile phone handset capable of switching between the GSM/GPRS/EDGE mode and the PHS mode adequately is required.

### SUMMARY OF INVENTION

An idea of the present invention is to provide a mode control method for switching a mobile wireless communication device between different communication modes according to a motion speed of the mobile wireless communication device.

An embodiment of the present invention discloses a communication mode control method used in a mobile wireless communication device. The mobile wireless communication device has a first communication mode and a second communication mode. The method comprises the following steps: calculating a motion speed of the mobile wireless communication device, and switching between the communication modes according to the motion speed.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram illustrating how the locations of a mobile wireless communication device are calculated.

FIG. 2 is a flow chart illustrating a method of the present invention.

FIG. 3 shows an example illustrating how the communication mode of a mobile wireless communication device is determined according to its motion speed.

FIG. 4 shows another example illustrating how the communication mode of a mobile wireless communication device is determined according to its motion speed.

### DETAILED DESCRIPTION

The Time Difference of Arrival (abbreviated as TDOA) and the Enhanced Observed Time Difference (abbreviated as E-OTD) are two kinds of technologies that can be used for calculating the location or specific coordinates of a mobile wireless communication device. By measuring the time differences for one same signal transmitted to three or more different base stations, system can calculate the distance between the mobile wireless communication device and the base stations. Using the information gathered, base station can calculate the location of the mobile wireless communication device from several intersects of the arcs with the base stations as circle centers.

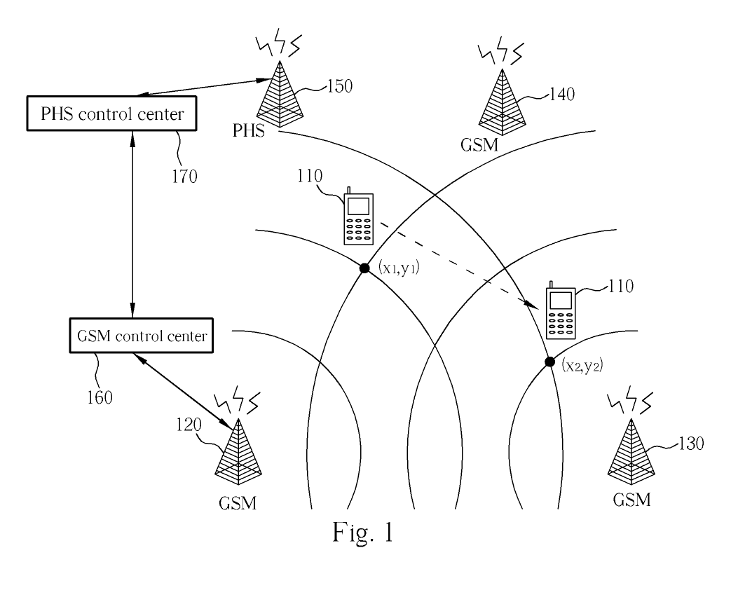

FIG. 1 is a diagram illustrating how the location of a mobile wireless communication device 110 is calculated. At a first time point t1, it is calculated that the mobile wireless communication device 110 is at a first location (x1,y1); at a second time point t2, it is calculated that the mobile wireless communication device 110 is at a second location (x2,y2). Using t1, t2, (x1,y1), and (x2,y2) as parameters, an average motion speed of the mobile wireless communication device 110 between t1 and t2 can be calculated. For example, assuming that the mobile wireless communication device 110 receives/transmits a packet with serial number A at the time point t1 and receives/transmits another packet with serial number B at the time point t2, the time base of each received/transmitted packet is T, and the distance between the first location (x1,y1) and the second location (x2,y2) is D. Therefore, the average motion speed S of the mobile wireless communication device 110 can be calculated according to the following equation:

$$S = \frac{D}{( B - A ) \times T}$$

Aside from the TDOA and E-OTD technologies, the Global Positioning System (abbreviated to GPS) provides another alternative for calculating the coordinates of a mobile wireless communication device. The Global Positioning System is made up of 24 satellites circling in 6 different orbits at an altitude of roughly 20,200 km. Each one of these satellites carries on sending radio signals which bring satellite orbit information and time information. A GPS receiver on the earth receives different radio signals sent by different GPS satellites. The coordinates of the GPS receiving device are then calculated based on the information carried by the received radio signals. Hence, a mobile wireless communication device applying the method of the present invention can use a built-in or attached GPS receiver to locate itself and determine the motion speed.

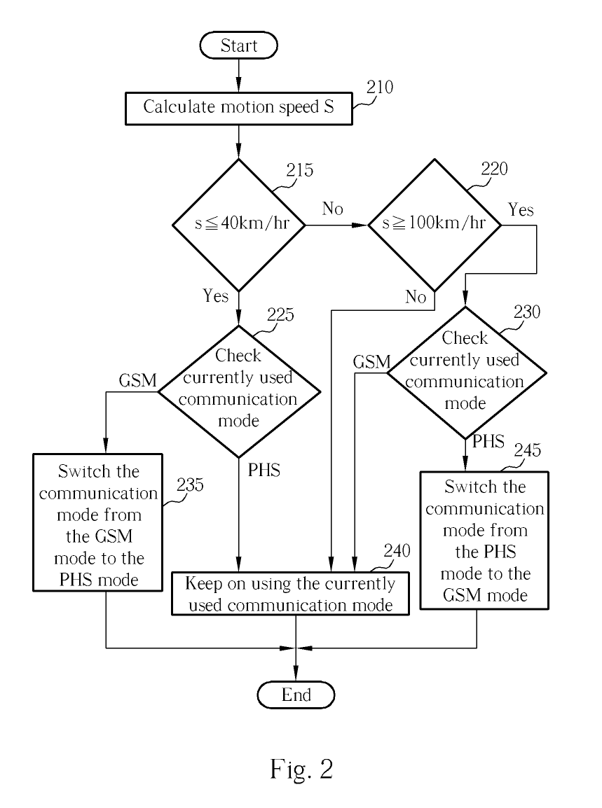

FIG. 2 is a flowchart illustrating the method of the present invention. In this example, the mobile wireless communication device is assumed to be a dual-mode handset, which has a first communication mode (ex. a PHS mode) and a second communication mode (ex. a GSM mode). The steps of this flow chart are as follows:

Step 210: Calculate a motion speed S of the dual-mode handset.

Step 215: Compare the motion speed S with a first threshold, which is 40 km/hr in this example. If the motion speed S is not greater than the first threshold, that is, if the motion speed S is smaller than or equal to the first threshold, enter step 225; otherwise, enter step 220.

Step 220: Compare the motion speed S with a second threshold, which is 100 km/hr in this example. If the motion speed S is not smaller than the second threshold, that is, if the motion speed S is greater than or equal to the second threshold, enter step 230; otherwise, enter step 240.

Step 225: Check currently used communication mode. If it is the GSM mode, enter step 235; if it is the PHS mode, enter step 240.

Step 230: Check currently used communication mode. If it's the GSM mode, enter step 240; if it's the PHS mode, enter step 245.

Step 235: At this time the currently used communication mode is the GSM mode. However, since the motion speed S of the dual-mode handset is not greater than 40 km/hr, using the PHS mode would be enough for both voice and data communication; PHS mode can reduces power consumption, and increases stand-by time of the dual-mode handset. Hence in this step, the method switches the communication mode of the dual-mode handset from the GSM mode to the PHS mode. Before mode switching, the dual-mode handset must establish wireless communication with a PHS base station first, then the wireless communication with a GSM base station can be terminated. In addition, before wireless communication with the GSM base station is terminated, the dual-mode handset can inform the GSM system to redirect received calls to the PHS system, and let the PHS system transmit calls received by the GSM system to the dual-mode handset. Hence, user will not miss calls which are dialed to the phone number used in GSM mode. That is, the dual-mode handset can receive calls from both systems when using only one communication mode.

Step 240: Continue to use the currently used communication mode. There are three possible situations. A first situation is that the currently used communication mode is the PHS mode, and the motion speed S is not greater than 40 km/hr; therefore the dual-mode handset keeps on using the PHS mode. A second situation is that the currently used communication mode is the GSM mode, and the motion speed S is not smaller than 100 km/hr; therefore the dual-mode handset keeps on using the GSM mode. A third situation is that the motion speed S lies between 40 km/hr and 100 km/hr; under this situation, the dual-mode handset keeps using the currently used communication mode regardless of whether the currently used communication mode is the GSM mode or the PHS mode.

Step 245: At this time the currently used communication mode is the PHS mode. However, since the motion speed S of the dual-mode handset is larger than 100 km/hr, it's possible that the communication quality under the PHS mode degrades to an unacceptable extent. Therefore, to assure communication quality, in this step, the method switches the communication mode of the dual-mode handset from the PHS mode to the GSM mode. Before mode switching, the dual-mode handset must establish wireless communication with a GSM base station first, then wireless communication with a PHS base station can be terminated. In addition, before wireless communication with the PHS base station is terminated, the dual-mode handset can inform the PHS system to redirect received calls to the GSM system, and let the GSM system transmit calls received by the PHS system to the dual-mode handset. Hence, user will not miss calls which are dialed to the phone number used in PHS mode. That is, the dual-mode handset can receive calls from both systems when using only one communication mode.

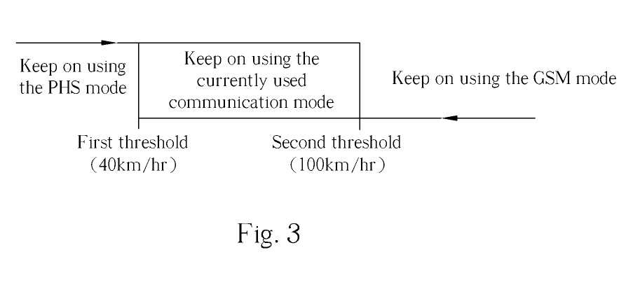

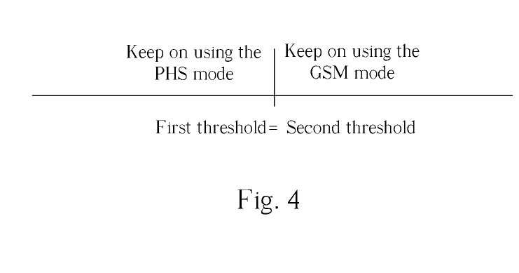

In the flow chart shown in FIG. 2, 40 km/hr and 100 km/hr are two determination criteria in the example. Please refer to FIG. 3. If the motion speed S lies between 40 km/hr and 100 km/hr, communication mode switching will not be executed. This avoids unduly mode switching, which can lead to unstable communication quality when the motion speed S changes drastically. Please note that 40 km/hr and 100 km/hr are just example values and other values can be used as threshold values. In addition, the first threshold can be equal to the second threshold, as shown in FIG. 4.

The call redirect function mentioned in step 234 and step 245 can be executed as follows. When the dual-mode handset is using the PHS system, a login number of the dual-mode handset is recorded in a first login list of the PHS system. When the dual-mode handset informs the PHS system about its mode switching (from the PHS mode to the GSM mode), the PHS system sends the login number of the dual-mode handset to the GSM system. Then the GSM system records the login number into the second login list. Hence, after the mode switching, calls which dial the PHS number of the dual-mode handset will be linked to the GSM system directly. Call redirect waiting time and GSM system login time are therefore reduced. Please note that other kinds of call redirect method can also be used with the present invention.

If the above mentioned E-OTD or TDOA technology is used for calculating the motion speed of the dual-mode handset, it is the system currently communicating with the dual-mode handset who is responsible for determining whether to switch the communication mode of the dual-mode handset, according to the calculated motion speed. On the other hand, if the GPS system is used, once the coordinates of the dual-mode handset are calculated by the GPS receiver of the dual-mode handset there are two possible solutions:

a. The dual-mode handset computes the motion speed of its own according to the coordinates calculated by the GPS receiver, and determines if it is necessary to switch communication mode. If it is necessary, the dual-mode handset makes a request to the currently used communication system.

b. The dual-mode handset reports the coordinates calculated by the GSP receiver to the currently used communication system. The currently used communication system calculates the motion speed of the dual-mode handset according to the received coordinates, and determines whether or not to switch the communication mode of the dual-mode handset.

Please note that motion speed in the above mentioned example is an average motion speed. In fact, the faster the processing speed and the more accurate sampling are, the better the average motion speed approaches the instantaneous motion speed. For example, if two adjacent packets with packet serial numbers equal to N and (N+1) are used for calculating the motion speed, the smaller the time base is, and the closer the calculated average motion speed approaches the instantaneous motion speed.

Please note that the method of the present invention could be used in any kind of mobile wireless communication device, such as personal digital assistants (PDA), notebook computers, etc. The method of the present invention is not limited to be applied to a dual-mode handset.

An advantage of the present invention is that after the motion speed of a mobile wireless communication device is calculated, the communication mode of the mobile wireless communication device can be determined automatically. When static or under a low motion speed, a communication mode with low transmission power is used, hence less power is consumed. Under a high motion speed, a communication mode with high transmission power is used for providing acceptable communication quality. The usefulness of the mobile wireless communication device is hence increased.

Those skilled in the art will readily observe that numerous modifications and alterations of the device and method may be made while retaining the teachings of the invention. Accordingly, the above disclosure should be construed as limited only by the metes and bounds of the appended claims.

1. A communication mode control method used in a mobile wireless communication device, the mobile wireless communication device having a first communication mode and a second communication mode, the method comprising:
calculating a motion speed of the mobile wireless communication device; and switching between the communication modes selectively according to the motion speed.

2. The method of claim 1, further comprising:
controlling the mobile wireless communication device to use the first communication mode if the motion speed is not greater than a first threshold; and
controlling the mobile wireless communication device to use the second communication mode if the motion speed is not smaller than a second threshold.

3. The method of claim 2, wherein the first threshold is smaller than the second threshold.

4. The method of claim 3, further comprising:
controlling the mobile wireless communication device to keep on using a currently used communication mode if the motion speed lies between the first threshold and the second threshold.

5. The method of claim 1, wherein the mobile wireless communication device is a mobile phone.

6. The method of claim 1, wherein the first communication mode is in accordance with the standard of a low power cell phone system, and the second communication mode is in accordance with the standard of a high power cell phone system.

7. The method of claim 1, wherein the mobile wireless communication device is wirelessly connected to a first wireless communication system when the first communication mode is used; the mobile wireless communication device is wirelessly connected to a second wireless communication system when the second communication mode is used; and the method further comprises:
informing the first wireless communication system to redirect calls of the first communication mode to the second wireless communication system in order to transmit the calls to the mobile wireless communication device through the second wireless communication system.

8. The method of claim 1, further comprising:
calculating a first location of the mobile wireless communication device at a first time point;
calculating a second location of the mobile wireless communication device at a second time point; and
calculating the motion speed of the mobile wireless communication device according to the first time point, the second time point, the first location, and the second location.

9. The method of claim 8, wherein the method uses Time Difference of Arrival (TDOA) technology to calculate the first location and the second location of the mobile wireless communication device at the first time point and the second time point respectively.

10. The method of claim 8, wherein the method uses Enhanced Observed Time Difference (E-OTD) technology to calculate the first location and the second location of the mobile wireless communication device at the first time point and the second time point respectively.

11. The method of claim 8, wherein the method uses Global Positioning System (GPS) technology to calculate the first location and the second location of the mobile wireless communication device at the first time point and the second time point respectively.

12. A method used in a mobile wireless communication device for selectively controlling the mobile wireless communication device to communicate wirelessly with a first or a second wireless communication system, the method comprising:
calculating a motion speed of the mobile wireless communication device; and
controlling the mobile wireless communication device to communicate wirelessly with the first or the second wireless communication system according to the motion speed.

13. The method of claim 12, wherein the first wireless communication system maintains a first login list; the second wireless communication system maintains a second login list; the mobile wireless communication device has a login number; when the mobile wireless communication device communicates with the first wireless communication system, the login number is recorded in the first login list; when the mobile wireless communication device switches to the second wireless communication system, the first wireless communication system sends the login number to the second wireless communication system to record in the second login list.

14. The method of claim 12, wherein when the mobile wireless communication device communicates with the first wireless communication system, the first wireless communication system calculates the motion speed and determines whether or not the mobile wireless communication device switches to the second wireless communication system.

15. The method of claim 14, wherein the first wireless communication system computes the motion speed by using Time Difference of Arrival (TDOA) technology or Enhanced Observed Time Difference (E-OTD) technology.

16. The method of claim 12, wherein when the mobile wireless communication device communicates with the first wireless communication system wirelessly, the mobile wireless communication device calculates the motion speed and determines whether or not switch to the second wireless communication system.

17. The method of claim 16, wherein the mobile wireless communication device comprises a Global Positioning System (GPS) receiver, and the mobile wireless communication device calculates the motion speed according to coordinates calculated by the GPS receiver within a time period.

18. The method of claim 12, wherein the first wireless communication system is a low power cell phone system, the second communication system is a high power cell phone system, and the mobile wireless communication device is a cell phone.

19. The method of claim 12, further comprising:
controlling the mobile wireless communication device to communicate with the first wireless communication system if the motion speed is not greater than a first threshold; and
controlling the mobile wireless communication device to communicate with the second wireless communication system if the motion speed is not smaller than a second threshold.

20. The method of claim 19, further comprising:
controlling the mobile wireless communication device to keep on communicating with a currently used communication system if the motion speed lies between the first threshold and the second threshold.
